(19) United States
(12) Patent Application Publication
(10) Pub. No.: US 2025/0161995 A1
(43) Pub. Date: May 22, 2025

(54) High pressure cleaning device

(71) Applicant: Andreas Stihl AG & Co. KG, Waiblingen (DE)

(72) Inventors: Simon Trinkle, Kaisersbach (DE); Christopher Tost, Auenwald (DE); Michael Renz, Stuttgart (DE)

(73) Assignee: Andreas Stihl AG & Co. KG, Waiblingen (DE)

(21) Appl. No.: 18/953,246

(22) Filed: Nov. 20, 2024

(30) Foreign Application Priority Data
Nov. 22, 2023 (EP) 23211447.0

(51) Int. Cl. B08B 3/02

(52) U.S. Cl. CPC B08B 3/028; B08B 2203/0205; B08B 2203/027

(57) ABSTRACT

A pressure washer includes a port for a liquid source, a high-pressure pump, a main line, through which liquid can be conveyed from the port to a spray opening of the main line by the high-pressure pump, a control element for setting a pressure value for the pressure in the main line, and a pressure regulator, which adjusts the pressure in the main line according to the pressure value set by the control element. The control element is continuously adjustable along a travel path. Each position of the control element sets a specific pressure value. The pressure washer has a selector element for selecting at least two different characteristic curves, each with a different relationship between positions of the control element and pressure values. By selecting a characteristic curve using the selector element, the assignment of the position of the control element to the pressure value can be changed.

### CROSS-REFERENCE TO RELATED APPLICATION

This application claims the benefit of European Patent Application EP 23211447.0, filed on Nov. 22, 2023, the content of which is incorporated by reference in its entirety.

### BACKGROUND

WO 2016/102075 A1 discloses a pressure washer in which the pressure in the pressure chamber of the pressure washer can be adjusted in stages. For this purpose, an input unit is arranged on the gun of the pressure washer. The input unit for step-by-step adjustment of the pressure is designed separately from an operating lever, which serves to open a valve in the main line of the pressure washer. Only when this main line valve is opened using the operating lever can water be sprayed from the gun of the pressure washer. A pressure level is selected using the input unit and then the main line valve is opened using the operating lever. Adjusting the pressure level while liquid is being sprayed is only possible in an uncomfortable way; during spraying, the operating lever is pressed with one finger and either the other hand or the thumb must be used to adjust the pressure. It is difficult to operate the pressure washer with one hand.

### SUMMARY

The disclosure relates to a pressure washer, which comprises a port for a liquid source, a high-pressure pump, a main line, through which liquid can be conveyed from the port to a spray opening of the main line by the high-pressure pump, a control element for setting a pressure value for the pressure in the main line, and a pressure regulator, which adjusts the pressure in the main line according to the pressure value set by the control element.

The disclosure is based on the object of improving a known pressure washer in such a way that a comfortable adjustment of the pressure is possible. This object is achieved by a pressure washer as disclosed and claimed.

In a solution to the object the main line of the pressure washer has a suction chamber between the port and the high-pressure pump. A pressure chamber is in the main line between the high-pressure pump and the spray opening. The pressure regulator has a bypass line with a bypass valve. The bypass line fluidically connects the pressure chamber with the suction chamber. To regulate the pressure in the pressure chamber, an open cross-sectional area of the bypass line can be adjusted using the bypass valve. The pressure regulator adjusts the open cross-sectional area of the bypass valve depending on the pressure value set by the control element. The control element is continuously adjustable along a travel path. Each position of the control element sets a specific pressure value. The travel path of the control element includes several travel path sections that are directly adjacent to one another. In particular, the position of the travel path sections may depend on the direction in which the position of the control element is changed. However, it can also be provided that the position of the travel path section is invariably fixed. Each travel path section includes several different positions of the control element. In each travel path section, a single pressure value is set by the control element. The pressure values of at least two travel path sections are different. In particular, the pressure values of at least three travel path sections are different.

In particular, the travel path of the control element has a total length. Advantageously, the length of a travel path section is at least 10%, advantageously at least 20%, in particular at least 30%, of the total length of the travel path. The length of the travel path or travel path section can be measured in degrees of an angle or as the actual distance traveled.

Because each travel path section includes several different positions of the control element and a single pressure value is set by the control element in each travel path section, a certain amount of play in the control element is possible without a change in the set pressure. This makes it easier for the operator to maintain a desired pressure over a longer period of time. However, a pressure change is also possible without problems, in that the travel path of the control element has several travel path sections that are directly adjacent to one another, and in that a single pressure value is set by the control element in each travel path section. To switch from one pressure value to another, the operator simply needs to move the control element a little further along the travel path. This can be done with one and the same finger. It is not necessary to reach around or actuate another control element to set a different pressure value.

Advantageously, the pressure values in the travel path sections increase, in particular continuously, at least within a subsection of the travel path along the travel path from a starting position of the subsection with a low pressure value to an end position of the subsection with a high pressure value. This enables intuitive operation of the operating lever. By pressing the operating lever harder, i.e. by covering a greater distance along the travel path, a different, in particular a higher, pressure value can be set. By simply operating the control element, the set pressure value can be increased. In an analogous manner, it is easy to set a lower pressure value by moving along the travel path in the opposite direction. In particular, the control element is biased from the end position of the subsection with a high pressure value toward the start position of the subsection with a low pressure value. When the control element is released, a lower pressure value is set due to the bias of the control element.

In particular, the subsection extends over the entire travel path of the control element. This means that the entire travel path of the control element is used for intuitive pressure value setting via the control element.

In an advantageous configuration, it is provided that the relationship between pressure values and travel path sections has a hysteresis, so that the division of the travel path into the set value ranges depends on which pressure value the control element has set before entering a set value range. In particular, the division of the travel path in the set value range depends on whether the control element is moved toward the start position or toward the end position. This prevents the pressure or pressure value from jumping back and forth after a transition from one pressure value to the other pressure value. It is also avoided that the pressure regulator, when the control element is in a position at the boundary between two adjacent travel path sections, sets different pressures in the event of slight fluctuations of the control element along the travel path.

In particular, the travel path sections each have an edge region. In the edge region, the control element sets a larger pressure value or a smaller pressure value depending on which pressure value the control element had set immediately before entering the edge region, in particular into the adjacent set value range. In particular, the control element specifies a larger pressure value or a smaller pressure value in the edge region depending on whether the control element is moved toward the start position or toward the end position. In particular, the control element sets the pressure value in the edge region that it had set immediately before entering the edge region.

It is advantageously provided that the pressure washer is designed in such a way that the high-pressure pump is operated at a constant output regardless of the position of the control element during operation of the pressure washer. This allows a uniform utilization of the high-pressure pump during operation of the pressure washer. This allows gentle operation of the pressure washer and the high-pressure pump. Because the pressure in the main line can be adjusted independently of the power of the high-pressure pump of the pressure washer, a reliable and precise adjustment of the pressure in the main line is possible. The open cross-sectional area of the bypass valve is precisely adjustable depending on the pressure value set by the control element.

In an advantageous configuration of the pressure washer, the control element is continuously adjustable along a travel path. Each position of the control element sets a specific pressure value. The pressure washer has a selector element for selecting at least two different characteristic curves, in particular at least three different characteristic curves, each with a different relationship between the position of the control element and the pressure value. By selecting a characteristic curve using the selector element, the assignment of the position of the control element and the pressure value can be set and/or changed. This allows the operator to select different characteristic curves for different applications. For example, a characteristic curve with a “fast” pressure rise or one with a “fine” pressure rise may be selected. In the case of a characteristic curve with a fast pressure rise, the control element only has to travel a short distance along the travel path of the control element in order to already set a high pressure value. With a fine characteristic curve, the pressure rise occurs only gradually along the travel path of the control element. This results in a completely different user experience for the operator, with the pressure washer remaining otherwise unchanged. By selecting the characteristic curves, the operator can aggressively or gently clean an object to be cleaned using the pressure washer.

In particular, the pressure washer has a hand-held spray unit. The spray opening is arranged on the hand-held spray unit. Advantageously, the selector element is arranged on the hand-held spray unit. In particular, the selector element is non-detachably arranged on the hand-held spray unit. This makes it easy to operate the selector element.

In particular, the control element is arranged on the hand-held spray unit. Advantageously, the selector element is arranged on the hand-held spray unit in such a way that it can be operated by a user with the thumb of one hand if, at the same time, a three-jointed finger of the same hand rests against the control element. This allows the selector element to be operated in a simple and comfortable manner while the control element is being actuated.

In particular, various nozzles can be arranged at the spray opening. Advantageously, the assignment of the position of the control element and the pressure value can be changed by selecting different characteristic curves using the selector element, with the same nozzle being arranged at the spray opening unchanged. To change the assignment of the position of the control element and the pressure value, a different characteristic curve can simply be selected using the selector element. For this purpose, it is not necessary for another nozzle to be arranged at the spray opening.

In particular, a second characteristic curve lies completely above a first characteristic curve, so that a greater pressure value is always set based on the second characteristic curve than based on the first characteristic curve at the same position of the control element. The second characteristic curve can be described as more aggressive than the first characteristic curve. The first characteristic curve can be described as more sensitive than the second characteristic curve.

In particular, the pressure washer is configured to allow a change between the first characteristic curve and the second characteristic curve by actuating the selector element during operation of the pressure washer. This allows convenient operation of the pressure washer and the selector element.

In an advantageous configuration, it is provided that all characteristic curves are free of intersection points with other characteristic curves. If, for a specific position of the control element, the pressure value assigned by a first characteristic curve is below a pressure value assigned by the second characteristic curve, for all other positions of the control element the pressure value of the first characteristic curve is smaller than the pressure value of the second characteristic curve for the same position of the control element.

In an advantageous configuration, at least two, in particular at least three characteristic curves have different slopes at least in sections. The term “slope” is not to be understood in a strictly mathematical sense in this context. Rather, it means that, at least on average, a different change in the set pressure value is achieved with the same travel of the control element. As a result, the operator also perceives a characteristic curve with a large slope as aggressive and a characteristic curve with a small slope as fine.

The control element has a start position. The pressure value set in the start position is expediently different depending on the characteristic curve selected by the selector element. This means that a characteristic curve can already have a high or low pressure value in the start position. In the case of a high pressure value in the start position, a large pressure value can so be set by the control element quickly without the control element having to be pressed strongly or having to travel a large distance along the travel path. In this way, rapid cleaning with high pressure is possible for a characteristic curve with a high pressure value in the start position.

The control element has an end position. In an advantageous further development, the control element is provided with a boost position. Expediently, the control element passes the end position before reaching the boost position along the travel path starting from the start position. Advantageously, during the transition from the end position to the boost position, the pressure value set by the control element increases abruptly. In particular, this can be provided for each characteristic curve. However, it can also be provided that this is provided only for one or some of the characteristic curves. This can give the user the feeling of a boost at the end of the characteristic curve. When the control element is fully pressed or when the control element is moved from the end position to the boost position, a maximum pressure value can be transmitted by the control element. In this way, the pressure regulator can adjust and effect the greatest pressure in the main line during maximum actuation of the control element.

### BRIEF DESCRIPTION OF THE DRAWINGS

Embodiments of the invention are explained below with reference to the drawings.

FIG. 1 is a schematic view of a pressure washer with the control element not being actuated and the bypass valve being open.

FIG. 2 shows a schematic view of the pressure washer from FIG. 1 with the control element actuated and the bypass valve closed.

FIG. 3 shows a characteristic curve of the pressure washer from FIG. 1, in which the pressure value transmitted by the control element is plotted over the position of the control element along the travel path of the control element.

FIG. 4 shows the characteristic curve of FIG. 3, wherein in the area of the hysteresis of the characteristic curve, the direction of the change from a pressure value set by the control element to the adjacent value is indicated.

FIG. 5a presents a schematic diagram illustrating the relationship between the back pressure experienced by the operator and the position of the control element along its travel path during operation.

FIG. 5b shows three different characteristic curves of the pressure washer from FIG. 1, in which the pressure value set by the control element is plotted over the position of the control element along the travel path of the control element.

FIG. 6 shows two different characteristic curves of the pressure washer from FIG. 1, each of which shows a staircase-shaped profile for the relationship between the pressure value transmitted by the control element and the position of the control element along the travel path of the control element.

### DETAILED DESCRIPTION

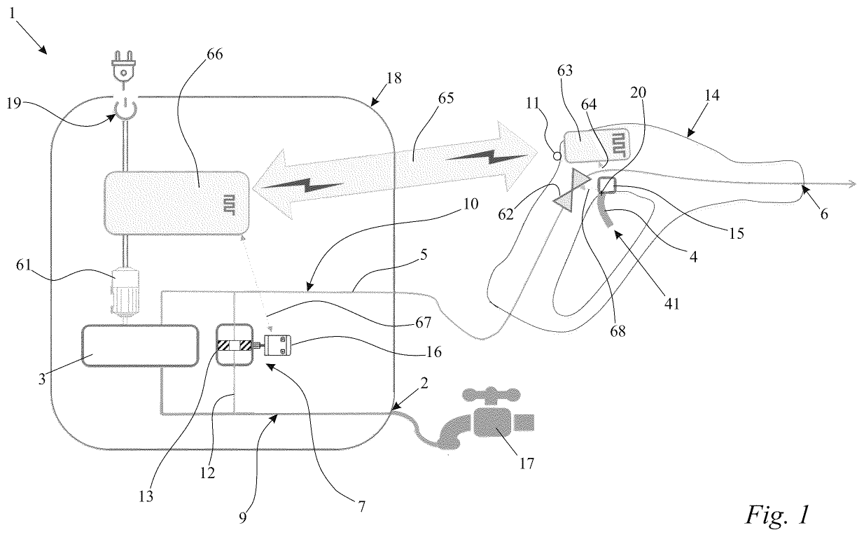

FIG. 1 shows a pressure washer 1, which may also be referred to as a high-pressure cleaning apparatus or high-pressure cleaning device. The pressure washer 1 is used to spray out a cleaning liquid pressurized by the pressure washer 1. The pressure washer 1 comprises a pump unit 18 and a spray unit 14. The spray unit 14 can be operated by hand when the pressure washer 1 is used as intended. The pump unit 18 and the spray unit 14 are fluidically connected to one another via a main line 5. In the exemplary embodiment, the spray unit 14 comprises a spray gun. However, it can also be provided that the spray unit comprises a gun and a lance.

The pressure washer 1 comprises a port 2 for a liquid source 17. In the exemplary embodiment, the liquid source 17 is an external liquid source. In the exemplary embodiment, the external liquid source is the tap of a domestic water network. It can also be provided that the liquid source is an integral part of the pressure washer.

The pressure washer 1 comprises a spray opening 6. The pressure washer 1 comprises the main line 5. The main line 5 of the pressure washer 1 fluidically connects the port 2 to the spray opening 6. The port 2 is arranged on the pump unit 18. The spray opening 6 is arranged on the spray unit 14. In the exemplary embodiment, the spray opening 6 is arranged on the spray unit 14 designed as a gun. However, it can also be provided that the spray opening is arranged on a replaceable lance of the spray unit.

The pressure washer 1 comprises a high-pressure pump 3. By means of the high-pressure pump 3, liquid can be conveyed from the port 2 to the spray opening 6 through the main line 5. The liquid source 17 supplies liquid to the main line 5. The high-pressure pump 3 is arranged in the main line 5. The high-pressure pump 3 pressurizes the liquid. By means of the high-pressure pump 3, the cleaning liquid can be placed under a pressure of at least 10 bar, in particular of at least 15 bar, in particular of at least 30 bar, in particular of at least 100 bar. In particular, the high-pressure pump 3 can pressurize the cleaning fluid to a maximum of 600 bar, in particular a maximum of 500 bar.

The high-pressure pump 3 is arranged between a suction chamber 9 and a pressure chamber 10 of the main line 5. The suction chamber 9 is in the main line between the port 2 and the high-pressure pump 3. The pressure chamber 10 is in the main line 5 between the high-pressure pump 3 and the spray opening 6. In the exemplary embodiment, the suction chamber 9 is formed by a section of the main line 5 between the port 2 and the high-pressure pump 3. In the exemplary embodiment, the pressure chamber 10 is formed by a section of the main line 5 between the high-pressure pump 3 and the spray opening 6. The high-pressure pump 3 pumps liquid from the suction chamber 9 to the pressure chamber 10. During operation of the pressure washer 1, in particular during operation of the high-pressure pump 3, the pressure in the pressure chamber 10 is higher than the pressure in the suction chamber 9. The suction chamber 9 and the pressure chamber 10 are part of the main line 5. The pressure in the main line 5 downstream of the high-pressure pump 3 is greater than the pressure in the main line 5 upstream of the high-pressure pump 3.

The high-pressure pump 3 is embodied separately from the spray unit 11. Various spray units can be connected to the high-pressure pump 3. The pressure washer 1 has a motor 61 to drive the high-pressure pump 3. The motor 61 is arranged in the pump unit 18. The motor 61 can be designed as a brushless DC motor. A brushless DC motor is also called an EC motor. The motor can also be a universal motor. In the exemplary embodiment, the motor 61 is an induction motor. In an induction motor, a rotating magnetic field of the stator sets the rotor in motion. In the exemplary embodiment, the induction motor is operated with alternating voltage. The voltage source can be provided, for example, by the mains voltage. If battery or rechargeable battery operation is planned, the motor can also be a brushless DC motor. It can then be provided that the rechargeable battery is a component of the pressure washer 1.

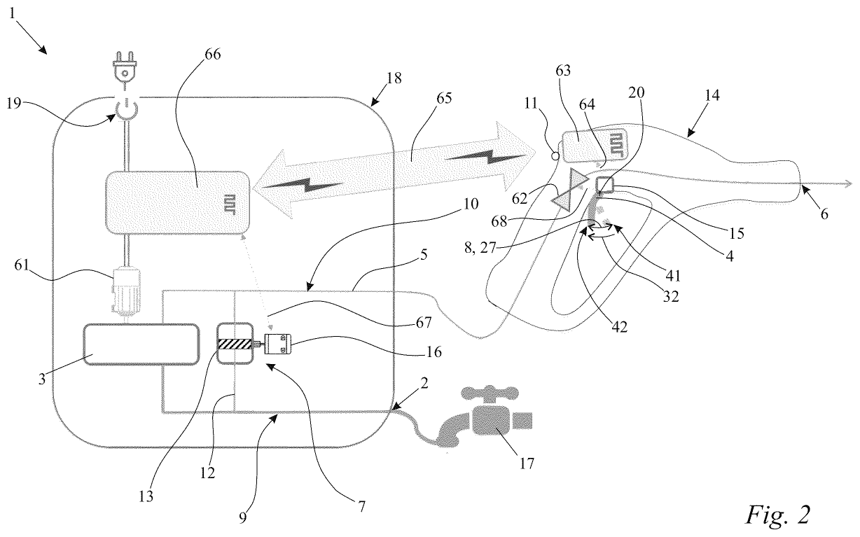

As shown in FIGS. 1 and 2, the pressure washer 1 comprises a main switch 19. The main switch 19 serves to interrupt the power supply of the entire pressure washer 1, in particular of the motor 61. The main switch 19 is arranged on the pump unit 18.

The pressure washer 1 comprises a main line valve 62. The main line valve 62 is arranged in the main line 5. The main line valve 62 has two valve states. The two valve states include a closed state (FIG. 1) and an open state (FIG. 2). In the open state, the main line valve 62 allows liquid to flow through the main line 5. In the closed state, the main line valve 62 prevents the flow of liquid through the main line 5. In the open state of the main line valve 62, liquid is sprayed out of the spray opening 6. In the closed state of the main line valve 62, no liquid is sprayed out of the spray opening 6. In the exemplary embodiment, the main line valve 62 is arranged in the spray unit 14. However, it can also be provided that the main line valve is arranged in the pump unit. It can also be provided that the main line valve is arranged between the port and the high-pressure pump.

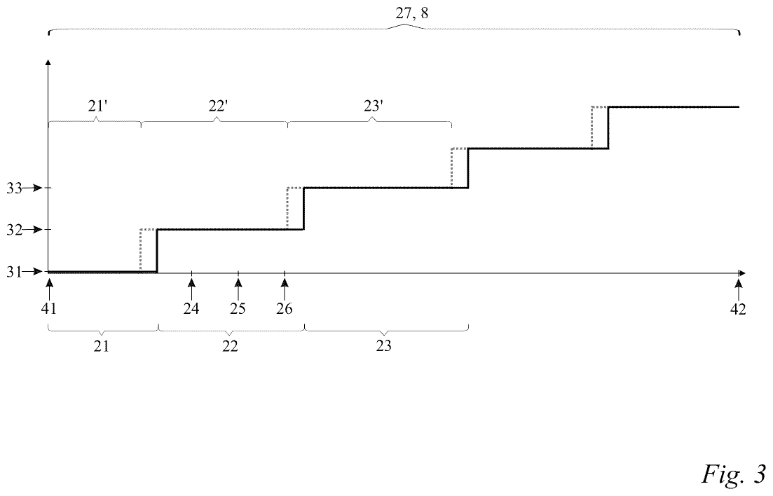

The pressure washer 1 has a control element 4. The control element 4 is formed separately from the main switch 19. The control element 4 is used to set a pressure value 31, 32, 33, for example shown in FIG. 3, for the pressure in the main line 5. As shown in FIGS. 1 and 2, the pressure washer 1 comprises a pressure regulator 7. The pressure regulator 7 is used to set the pressure in the main line 5 in accordance with the pressure value 31, 32, 33 specified by the control element 4.

The control element 4 is continuously adjustable along a travel path 8 of the control element 4 shown in FIG. 2. Each position of the control element 4 along the travel path 8 corresponds to a specific pressure value 31, 32, 33. Each position of the control element 4 sets a specific pressure value 31, 32, 33.

In the exemplary embodiment, the pressure washer 1 is designed in such a way that a pressure value 31, 32, 33 set by a specific position of the control element 4 is transmitted to the pressure regulator 7. The pressure regulator 7 adjusts the pressure in the main line 5 in accordance with this set pressure value 31, 32, 33.

In the exemplary embodiment, the pressure regulator 7 comprises a bypass line 12. The pressure chamber 10 is fluidically connected to the suction chamber 9 by the bypass line 12. The bypass line 12 allows a further fluidic connection of the suction chamber 9 and the pressure chamber 10 separately from the fluidic connection of the suction chamber 9 to the pressure chamber 10 via the high-pressure pump 3.

When the high-pressure pump 3 is in operation, the pressure in the pressure chamber 10 is higher than in the suction chamber 9. Due to this pressure gradient, liquid can flow from the pressure chamber 10 into the suction chamber 9 through the bypass line 12. A bypass valve 13 is arranged in the bypass line 12. The bypass valve 13 is part of the pressure regulator 7. An open cross-sectional area of the bypass line 12 can be adjusted using the bypass valve 13. This makes it possible to regulate the pressure in the pressure chamber 10. With a larger open cross-sectional area, the pressure compensation between the pressure chamber 10 and the suction chamber 9 takes place to a greater extent. If a high pressure is desired in the pressure chamber 10, the open cross-sectional area of the bypass line 12 is reduced by means of the bypass valve 13. The larger the open cross-sectional area of the bypass line 13, the greater the volume flow through the bypass line 13 during operation, under otherwise unchanged conditions.

The bypass valve 13 can be adjusted in discrete steps or continuously between a fully closed state and a fully open state. The bypass valve 13 can have different degrees of closure between the fully closed state and the fully open state. In the exemplary embodiment, the bypass valve 13 is continuously adjustable, at least in sections. It can also be provided that the bypass valve can be continuously adjusted between the fully closed state and the fully open state without interruption.

The magnitude of the volume flow of the liquid in the main line, in particular in the pressure chamber 10 of the main line 5, can be adjusted as a function of the degree of closure of the bypass valve 13. The more the bypass valve 13 is closed, the smaller the open cross-sectional area of the bypass line 12. The more the bypass valve 13 is closed, the greater the volume flow of the liquid in the main line 5. The more the bypass valve 13 is closed, the greater the volume flow of the liquid in the main line 5, which is present at the spray opening 6.

The bypass valve 13 can be adjusted using the control element 4. This is used to adjust the open cross-sectional area of the bypass line 12. By adjusting the bypass valve 13, the pressure in the main line 5, in particular in the pressure chamber 10, in particular at the spray opening 6, can be regulated.

In the exemplary embodiment, the main line valve 62 can be switched between the open state and the closed state by means of the control element 4. In the exemplary embodiment, the control element 4 is arranged on the spray unit 14. In the exemplary embodiment, the control element 4 can be used to switch the main line valve 62 between the open state and the closed state and also to set a pressure value 31, 32, 33 for the pressure regulator 7. In particular, the control element 4 can be used to switch the main line valve 62 between the open state and the closed state and also to adjust the bypass valve 13.

The spray unit 14 is movable relative to the pump unit 18. In the exemplary embodiment, the main line 5 is designed as a flexible hose between the pump unit 18 and the spray unit 16. The spray opening 6 is arranged on the spray unit 14. The spray unit 14 can be directed with its spray opening 6 onto an object that is to be cleaned. The spray unit 14 can be operated by hand when the pressure washer 1 is used as intended. The control element 4 is arranged on the spray unit 14. A user can guide the spray unit 14 with one hand and simultaneously operate the control element 4 with the same hand.

The hand-held spray unit 14 has a handle area. The control element 4 is located in the handle area. The pressure washer 1 is designed in such a way that a user can hold the hand-held spray unit 14 by gripping the handle area with one hand and at the same time can actuate the control element 4 with one finger of the same hand. In the exemplary embodiment, the finger is the index finger. In the exemplary embodiment, actuation of the control element 4 with the thumb is not anticipated.

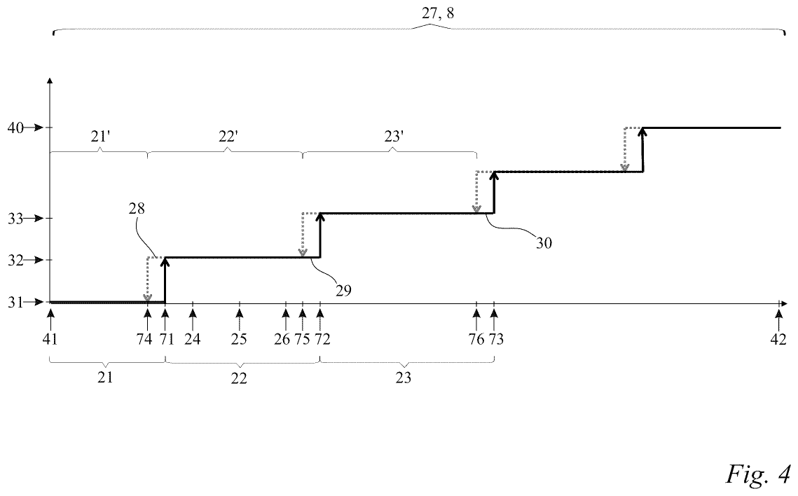

Depending on the position of the control element 4, the control element 4 sets a pressure value 31, 32, 33. The control element 4 is continuously adjustable along the travel path 8. Each position of the control element 4 sets a specific pressure value 31, 32, 33. The travel path 8 of the control element 4 has a plurality of directly adjacent travel path sections 21, 22, 23, which are shown in FIGS. 3 and 4. In the exemplary embodiment according to FIGS. 3 and 4, the first travel path section 21, the second travel path section 22 and the third travel path section 23 are shown by way of example. The second travel path section 22 lies between the first travel path section 21 and the third travel path section 23. The second travel path section 22 is immediately adjacent to both the first travel path section 21 and the third travel path section 23.

Each travel path section 21, 22, 23 comprises several different positions 24, 25, 26 of the control element 4. In FIGS. 3 and 4, the first position 24, the second position 25 and the third position 26 are marked by way of example in the second travel path section 22. In each travel path section 21, 22, 23, a single pressure value 31, 32, 33 is set by the control element 4. The pressure values 31, 32, 33 of at least two, in particular of at least three travel path sections 21, 22, 23 are different. In the embodiment according to FIGS. 3 and 4, there are a total of five different travel path sections, each with different pressure values. In the first position 24, the second position 25 and the third position 26 of the second travel path section 22, the control element 4 sets the same pressure value. In each travel path section 21, 22, 23, there are at least three positions 24, 25, 26 of the control element 4, in which the same pressure value 31, 32, 33 is set. In the second travel path section 22, the control element 4 sets the second pressure value 32 in the first position 24. In the second position 25, the control element 4 also sets the second pressure value 32. In the third position 26, the control element 4 also sets the second pressure value 32. In the first travel path section 21, the control element 4 sets the first pressure value 31. Analogously to the second travel path section 22, this is also the case in the first travel path section 21 for at least three different positions of the control element 4. In the third travel path section 23, the control element 4 sets the third pressure value 33. Analogously to the second travel path section 22, this is also the case in the third travel path section 23 for at least three different positions of the control element 4.

The control element 4 has a non-actuated state shown in FIG. 1. The control element 4 has a fully actuated state shown in FIG. 2. In the fully actuated state, the control element 4 is deflected to the maximum extent. The control element 4 is biased toward the non-actuated state. A spring (not shown in the figures) can be used for this purpose. The travel path 8 extends between the position that the control element 4 assumes in the non-actuated state and the position that the control element 4 assumes in the fully actuated state.

In the exemplary embodiment, the control element 4 is a pivot lever. The pivot lever operates as a progressive trigger. The control element 4 is pivotable about a pivot axis 20 shown in FIG. 1. In the fully actuated state of the control element 4, the control element 4 is pivoted by a maximum angle. The maximum angle may be a value between 20° and 70°, in particular between 30° and 60°, in the exemplary embodiment between 40° and 50°. In the exemplary embodiment, a travel path section 21, 22, 23 extends over at least 10%, in particular over at least 15%, of the extent of the travel path 8. In the case of the control element 4 that can be pivoted according to the exemplary embodiment, a travel path section 21, 22, 23 covers at least an angular range of 10°, in particular of at least 5°. However, smaller values may also be provided for the extent of the travel path sections 21, 22, 23. In the exemplary embodiment, a travel path section 21, 22, 23 extends over at most 40%, in particular over at most 30%, of the extent of the travel path 8. In the case of the control element 4 that can be pivoted according to the exemplary embodiment, a travel path section 21, 22, 23 covers at most an angular range of 30°, in particular of at most 20°.

The pressure values 31, 32, 33 are different. In the exemplary embodiment, the second pressure value 32 is greater than the first pressure value 31. The third pressure value 33 is greater than the second pressure value 32. Within a subsection 27 (FIGS. 2, 3 and 4), the pressure values 31, 32, 33, which are respectively assigned to the different travel path sections 21, 22, 23, increase from one to the next along the travel path 8 from a start position 41 (FIG. 1) to an end position 42 (FIG. 2) of the control element 4, in particular with respect to different travel path sections 21, 22, 23. A low pressure value 31 is assigned to the start position 41. A high pressure value 40 is assigned to the end position 42. In the exemplary embodiment, the subsection 27 extends over the entire travel path 8 of the control element 4. The start position 41 corresponds to the position of the control element 4 in the non-actuated state. The end position 42 corresponds to the position of the control element 4 in the fully actuated state. However, it can also be provided that the subsection 27 extends over only a part of the travel path 8 of the control element 4.

The pressure washer 1 comprises a detector 15 shown in FIGS. 1 and 2. The detector 15 is designed to detect a position of the control element 4. The position of the control element 4 is also referred to as the adjustment position. The detector 15 can detect any position of the control element 4 within the travel path 8. It can be provided that the detector 15 is a Hall sensor. In the exemplary embodiment, the detector 15 is a potentiometer. The control element 4 and the detector 15 are arranged on the spray unit 14 in such a way that the adjustment position of the control element 4 can be detected. The control element 4 interacts with the detector 15. The detector here operates as an angular position sensor.

The pressure washer 1 is designed such that the pressure regulator 7 adjusts the pressure in the main line 5, in particular in the pressure chamber 10 of the main line 5, as a function of the position of the control element 4 along the travel path 8. In particular, the pressure washer 1 is designed such that the bypass valve 13 of the pressure regulator 7 adjusts the size of the open cross-sectional area of the bypass line 12 as a function of the adjustment position of the control element 4. To set the pressure in the main line 5, the detector 15 detects the position of the control element 4 and generates a signal, on the basis of which the bypass valve 13 is adjusted. In the exemplary embodiment, part of this signal is an initial signal 64 (FIGS. 1 and 2). The initial signal 64 is generated by the detector 15 and forwarded to a transmitter unit 63. In the exemplary embodiment, the initial signal 64 is an electrical signal. The initial signal 64 is forwarded to the transmitter unit 63 by means of a signal line, in the exemplary embodiment by a cable, i.e. a wired connection. It can also be provided that an electrical or electromagnetic signal is used directly to forward the pressure value to the pressure regulator 7, in particular to the bypass valve 13. It can also be provided that the initial signal 64 is an electromagnetic signal. In the exemplary embodiment, the transmitter unit 63 is arranged on the spray unit 14. The pressure regulator 7 adjusts the pressure in the main line 5 in accordance with the signal generated by the control element 4. In the exemplary embodiment, the bypass valve 13 is adjustable by means of the signal generated by the control element 4. In the exemplary embodiment, the signal can be transmitted wirelessly. Based on the initial signal 64 transmitted from the detector 15 to the transmitter unit 63, an electromagnetic signal 65 is generated in the transmitter unit 63. The electromagnetic signal 65 is part of the signal sent from the control element 4 for setting the pressure in the main line 5 by means of the pressure regulator 7. In particular, the electromagnetic signal 65 is part of the signal sent from the control element 4 for setting the open cross-sectional area of the bypass line 12.

The pressure washer 1 has a control unit 66 shown in FIGS. 1 and 2. The control unit 66 is arranged in the pump unit 18. The electromagnetic signal 65 is transmitted from the transmitter unit 63 to the control unit 66. The electromagnetic signal 65 received by the control unit 66 is used to adjust the pressure in the main line 5. The electromagnetic signal 65 received by the control unit 66 is used to adjust the open cross-sectional area of the bypass line 12 by means of the bypass valve 13.

In the exemplary embodiment, the bypass valve 13 is adjustable by means of a servomotor 16. The servomotor 16 is part of the pressure regulator 7. The servomotor 16 is arranged in the pump unit 18. By means of the servomotor 16, the bypass valve 13 can be adjusted in such a way that the open cross-sectional area of the bypass line 12 can be adjusted. Based on the electromagnetic signal 65 received from the transmitter unit 63 in the control unit 66, an end signal 67 is generated in the control unit 66, which is transmitted to the servomotor 16. In the exemplary embodiment, the end signal 67 is transmitted electrically by a wire. However, it can also be provided that the end signal is transmitted wirelessly. In particular, the end signal can be an electromagnetic signal. The end signal 67 is part of the signal sent from the control element 4 for setting the pressure in the main line 5, in particular for setting the open cross-sectional area of the bypass line 12. Based on the end signal 67, the servomotor 16 adjusts the bypass valve 13. By means of the servomotor 16, the bypass valve 13 can be adjusted in such a way that a continuous adjustment of the size of the open cross-sectional area of the bypass line 12 is possible. The size of the open cross-sectional area can be continuously adjusted using the control element 4.

The control element 4 is arranged on the spray unit 14. The control element 4 is arranged in particular on the spray gun. The control element 4 is located in the handle area. The opening of the main line valve 62 by the control element 4 can be implemented mechanically. In the exemplary embodiment, however, this also results in a main line signal 68 being sent from the detector 15 to the main line valve 62. In the exemplary embodiment, this main line signal 68 is an electrical signal. As soon as the control element 4 is no longer in the non-actuated state, this is detected by the detector 15. The detector 15 generates the main line signal 68 that is communicated to the main line valve 62. This main line signal 68 causes the main line valve 62 to transition from the closed state to the open state. As long as the control element 4 is in the actuated state, i.e. not non-actuated, the main line signal 68 is still transmitted from the detector 15 to the main line valve 62 and so ensures that the main line valve 62 is in the open state, in particular in the fully open state.

In the exemplary embodiment, the pressure washer 1 is designed such that, in the non-actuated state of the control element 4, the bypass valve 13 is set such that the open cross-sectional area of the bypass line 12 is at a maximum. The pressure washer 1 is designed such that, before the maximum open cross-sectional area of the bypass line 13 is reduced by the control element 4, the main line valve 62 is switched from the closed state to the open state by means of the control element 4. The bypass valve 13 is not opened until the main line valve 62 has been opened.

In the exemplary embodiment, the pressure washer 1 is designed such that, before the control element 4 is transferred from the actuated state of the control element 4 to the non-actuated state of the control element 4, the bypass valve 13 is set such that the open cross-sectional area of the bypass line 12 is increased. Before the main line valve 62 is transferred from the open state to the closed state, the bypass valve 13 is at least partially opened.

As shown in FIG. 2, the control element 4 is adjustable along a travel path 8 from the non-actuated position into positions with increasing distance from the non-actuated position. In the exemplary embodiment, the non-actuated position corresponds to the start position 41. The control element 4 assumes the maximum distance from the non-actuated position or from the start position 41 in the fully actuated position. In the exemplary embodiment, the fully actuated position corresponds to the end position 42. The pressure washer 1 is designed in such a way that the bypass valve 13 reduces and/or at least does not increase the open cross-sectional area of the bypass line 12 as the distance between the control element 4 and the start position 41 increases. Due to the fact that each travel path section 21, 22, 23 comprises several different positions 24, 25, 26 of the control element 4, which are each assigned to a single pressure value 31, 32, 33 in the associated travel path section 21, 22, 23, the cross-sectional area of the bypass line 12 is reduced in steps when the control element 4 is pressed. During the transition from one travel path section 21, 22 to the immediately adjacent travel path section 22, 23, the pressure value 31, 32, 33 set by the control element changes abruptly. As the distance between the control element 4 and the non-actuated position or the start position 41 increases, the pressure in the main line 5, in particular in the pressure chamber 10, increases in steps. A smaller volume of the liquid delivered by the high-pressure pump 3 can flow back from the pressure chamber 10 into the suction chamber 9 via the bypass line 12. In the fully actuated position of the control element 4 or in the end position 42, the pressure in the main line 5, in particular in the pressure chamber 10, is at a maximum for the open state of the main line valve 62.

The pressure washer 1 is designed such that the high-pressure pump 3 is operated at a constant output regardless of the position of the control element 4 during operation of the pressure washer 1. It is not the pumping capacity of the high-pressure pump 3 that is changed by the control element 4, but the open cross-sectional area of the bypass line 12. This enables a particularly precise adjustment of the pressure in the main line 5, in particular in the pressure chamber 10.

There is no need for expensive and complicated phase control of the motor 61. The pressure in the main line 5, in particular in the pressure chamber 10, is controlled by adjusting the bypass valve 13. This can be done in a simple, uncomplicated and cost-effective way. In particular, this type of pressure adjustment allows the pressure to be adjusted independently of the type of motor 61 of the high-pressure pump 3.

The distance of the control element 4 to its non-actuated position refers to the distance of a reference point on the control element 4. In the embodiment, the control element 4 is a lever that can be pivoted about the pivot axis 20. In the embodiment, the reference point is the point of the control element 4 with the greatest distance to the pivot axis 20. In the exemplary embodiment, the non-actuated position of the control element 4 is defined by the position of the reference point when the control element 4 is not actuated.

When the control element 4, which is designed as a lever, is actuated out of the non-actuated position of the control element 4, the control element 4—and thus also the reference point—is pivoted along the travel path 8. In this case, the travel path 8 is a section of a circle. The distance of the control element 4 to the non-actuated position corresponds to the distance of the reference point to the non-actuated position measured along the travel path 8 designed as a circular line section. It can also be provided to measure the distance in the form of an angular distance of the reference point to the non-actuated position relative to a pivoting movement about the pivot axis 20.

In the exemplary embodiment, the control element 4 is a single component in which the functions of both actuating the main line valve and actuating the pressure regulator 7, in particular the bypass valve 13, are combined. The control element 4 is one-piece. The control element 4 can be operated with a single finger.

The pressure washer 1 is designed such that actuation of the control element 4 by a user during use of the pressure washer 1 is possible both for switching the main line valve 62 between the open state and the closed state and for setting a pressure value 31, 32, 33 for the pressure regulator 7, in particular for adjusting the bypass valve 13, using only a single finger, namely the index finger, the middle finger, the ring finger, or the little finger.

The pressure washer 1 is designed such that the actuation of the main line valve 62 to switch the main line valve 62 between the open state and the closed state and the actuation of the pressure regulator 7, in particular the actuation of the servomotor 16 to adjust the bypass valve 13, can be triggered by actuating the control element 4 by a single continuous movement of a single finger. In particular, during the single continuous movement, the main line valve 62 and then the pressure regulator 7, in particular the bypass valve 13, are actuated in succession. Depending on the operating state, the continuous movement takes place in the opposite direction. Correspondingly, during the single continuous movement, the pressure regulator 7, in particular the bypass valve 13, and then the main line valve 62 are actuated in succession.

When the control element 4 moves along the travel path 8 starting from the non-actuated position movement of the control element 4 out of the non-actuated position is first detected by the detector 15 when the control element 4 is actuated. The detector 15 then sends the main line signal 68 to the main line valve 62, which is then switched from the closed state to the open state. Only when the control element 4 is further adjusted along the travel path 8, that is to say when the control element 4, which is designed as a lever, is further removed from the non-actuated position of the control element 4, does the detector 15 transmit the initial signal 64 to the transmitter unit 63, on the basis of which an increase in the pressure in the main line 5, in particular in the pressure chamber 10, is brought about by the pressure regulator 7. In particular, due to the initial signal 64, a reduction in the maximum open cross-sectional area of the bypass line 12 is caused by the bypass valve 13 and the servomotor 16.

The transfer of the control element 4 from the actuated state (i.e. from the not non-actuated state) to the non-actuated state takes place in the reverse order. When the control element 4, which is designed as a lever, approaches the non-actuated position, a reduction in the pressure in the main line 5, in particular in the pressure chamber 10, is brought about by the pressure regulator 7. In particular, an increase in the open cross-sectional area of the bypass line 12 is first caused by adjusting the bypass valve 13 by means of the servomotor 16. It is only when the pressure in the main line 5, in particular in the pressure chamber 10, is at a minimum, in particular only when the open cross-sectional area of the bypass line 12 is at a maximum, that the main line valve 62 is transferred from the open state to the closed state by the detector 15, which detects a corresponding position of the control element 4 designed as a lever, due to a lack of a main line signal 68. It can also be provided that a different signal is provided for this purpose instead of the absence of the main line signal 68.

As shown in FIGS. 3, 4 and 6, the relationship between the pressure values 31, 32, 33 and the travel path sections 21, 22, 23 has a hysteresis. The division of the travel path 8 of the control element 4 into the set value ranges 21, 22, 23 depends on which pressure value 31, 32, 33 the control element 4 sets before entering the adjacent set value range 21, 22, 23. In particular, the division of the travel path 8 into the set value ranges 21, 22, 23 depends on whether the control element 4 is moved toward the start position 41 or toward the end position 42. As shown in FIG. 4, the travel path sections 21, 22, 23 have edge regions 28, 29. In the edge regions 28, 29, the control element 4 sets a larger pressure value 32, 33 or a smaller pressure value 31, 32 depending on which pressure value 31, 32, 33 the control element 4 had set before entering the adjacent travel path section 21, 22, 23, in particular whether the control element 4 is moved toward the start position 41 or toward the end position 42.

By way of example, FIG. 4 shows the edge regions 28 and 29 of the second travel path section 22 and of the second travel path section 22′, respectively.

As shown in FIG. 4, the travel path 8 is divided into the travel path sections 21, 22 and 23 when the control element 4 moves in the direction of the fully actuated position of the control element 4, in the exemplary embodiment in the direction of the end position 42. When the control element 4 moves, in particular exclusively, in the direction of the non-actuated position of the control element 4, in the exemplary embodiment in the direction of the start position 41 of the control element 4, the travel path 8 is divided into the travel path sections 21′, 22′ and 23′. The first travel path sections 21′ and 21 overlap. The second travel path sections 22′ and 22 overlap. The third travel path sections 23′ and 23 overlap. The first travel path section 21 and the second travel path section 22′ overlap. The overlap area between the first travel path section 21 and the second travel path section 22′ forms the edge region 28 of the first travel path section 21. The second travel path section 22 and the third travel path section 23′ overlap. The overlap region of the second travel path section 22 and the third travel path section 23′ forms the edge region 29 of the second travel path section 22. The travel path sections 21′ and 22′ are directly adjacent to one another. The travel path sections 22′ and 23′ are directly adjacent to one another. The travel path sections 21 and 22 are directly adjacent to one another. The travel path sections 22 and 23 are directly adjacent to one another. The travel path sections 21, 22 and 23 are also referred to as pressure increase travel path sections. The travel path sections 21′, 22′ and 23′ are also referred to as pressure decrease travel path sections. The travel path section 21′ is assigned to the travel path section 21. The travel path section 22′ is assigned to the travel path section 22. The travel path section 23′ is assigned to the travel path section 23. The travel path section 21′ is smaller than the travel path section 21. The travel path section 21 extends from the start position 41. The travel path section 21′ extends from the start position 41. The travel path section 22′ is displaced with respect to the travel path section 22 in the direction of the start position 41. The travel path section 22′ is the same size as the travel path section 22. The travel path section 23′ is displaced with respect to the travel path section 23 in the direction of the start position 41. The travel path section 23′ is the same size as the travel path section 23. The above description of the travel path sections 21, 22, 23 also applies in an analogous manner to the travel path sections 21′, 22′, 23′.

When the control element 4 is moved in the direction from the start position 41 to the end position 42 and is initially located in the first travel path section 21, the transition into the second travel path section 22 takes place in a first upshift position 71 of the control element 4. As soon as the first upshift position 71 of the control element 4 is reached, the control element 4 no longer sets the first pressure value 31, but the second pressure value 32. The second pressure value 32 is greater than the first pressure value 31. If the first upshift position 71 of the control element 4 is present starting from the smaller, first pressure value 31, the boundary of the first actuating travel path section 21 is defined by the first upshift position 71 of the control element 4. However, if the second pressure value 32 is present, i.e. the control element 4 is located in the second travel path section 22 and the control element 4 is moved in the direction from the end position 42 to the start position 41, the transition from the second travel path section 22′ into the first travel path section 21′ or into the first travel path section 21 does not take place in the first upshift position 71 of the control element 4, but in a first downshift position 74 of the control element 4. The first downshift position 74 is closer to the start position 41 of the control element 4 than the first upshift position 71 of the control element 4. Thus, if the control element 4 sets the second pressure value 32, i.e. is located in the second travel path section 22, and the control element 4 is moved in the direction of the start position 41, the first travel path section 21 or 21′ is not limited by the first upshift position 71, but by the first downshift position 74. The first travel path section is then given by the range identified by 21′ in FIG. 4. In the edge region 28, the first pressure value 31 or the second pressure value 32 can be set by the control element 4 depending on whether the control element 4 enters the edge region 28 starting from the second travel path section 22 or starting from the first travel path section 21′. After an upshift from the first pressure value 31 to the second pressure value 32, this prevents the pressure value from immediately jumping back to the first pressure value 31 in the event of slight fluctuations in the position of the control element 4. Conversely, this is analogously the case when the second pressure value 32 is switched down to the first pressure value 31. The edge regions 28, 29 amount to at least 2%, in the exemplary embodiment at least 5%, of the extent of the associated travel path section 21, 21′, 22, 22′, 23, 23′. The edge region 28 is assigned to the first travel path section 21 or the second travel path section 22′. The edge region 28 extends over at least 2%, in the exemplary embodiment over at least 5%, of the first travel path section 21. The edge region 29 is assigned to the second travel path section 22 or the third travel path section 23′. The edge region 29 extends over at least 2%, in particular over at least 5%, of the extent of the second travel path section 22. The description of the edge region 28 of the first travel path section 21 applies analogously to the edge region 29 of the second travel path section 22. In an analogous manner, the remaining travel path sections have an associated edge region. Analogously to the edge region 28, the edge region 29 is delimited by a second downshift position 75 and a second upshift position 72 of the control element 4. The edge region 30 assigned to the third travel path section 23 is limited by a third downshift position 76 and a third upshift position 73. In an analogous manner, the second upshift position 72 is further away from the non-actuated position of the control element 4 than the second downshift position 75 of the control element 4. Likewise, the third upshift position 73 is further away from the non-actuated position of the control element 4 than the third downshift position 76 of the control element 4.

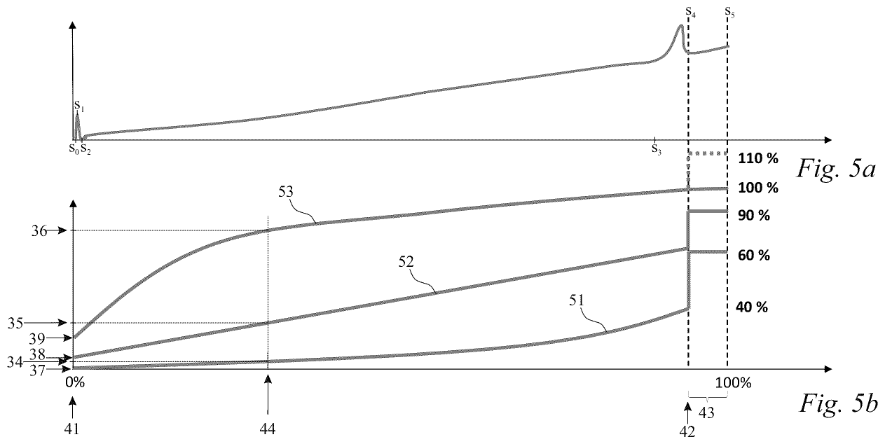

FIG. 5a shows a diagram in which the position of the control element 4 is plotted on the abscissa axis (x-axis). The counterpressure exerted by the control element 4 on an operator is plotted on the ordinate axis (y-axis). The position s₀ entered on the abscissa axis corresponds to the non-actuated position of the control element 4 shown in FIG. 1. The position s₅ corresponds to the fully actuated position of the control element 4 shown in FIG. 2. In between, the control element 4 assumes the positions s₁, s₂, s₃ or s₄. The following applies: s₀<s₁<s₂<s₃<s₄<s₅. Furthermore, s₁ s₂. Furthermore, s₁ s₃. In the position s₀, the main line valve 62 is closed. The bypass valve 13 is fully open. If the operator actuates the control element 4 in this situation, it first travels the distance from the position s₀ to the position s₁. The main line valve 62 is opened at the position s₁. To do this, the operator must apply a force to overcome the counter pressure of the control element 4. The counter pressure of the control element 4 rises on the path of the control element 4 from the position s₀ to the position s₁. The main line valve 62 is opened at the position s₁ of the control element 4.

If the control element 4 is further actuated, the control element 4 travels the distance from the position s₁ to the position s₂. In the region between the positions s₂ and s₃ of the path of the control element 4, the pressure value set by the control element 4 is increased. With a greater distance covered by the control element 4, the pressure value transmitted by the control element 4 becomes greater. Accordingly, the pressure regulator 7 ensures that the bypass valve 13 is further closed. The volume flow in the main line 5 increases. The pressure in the main line 5 increases. The control element 4 is biased toward the position s₀. In the exemplary embodiments, a spring presses the control element 4 into the position s₀. The counter pressure on the control element 4 increases slightly as the distance covered by the control element 4 increases due to the greater spring force.

The section of the path of the control element 4 between the positions s₃ and s₄ leads to the activation of a boost function. The boost function provides an even larger volume flow and thus a greater pressure for the liquid in the main line 5, particularly in the pressure chamber 10 in the area of the spray opening 6. To reach this section, the operator must first apply a greater force to the control element 4. If the operator continues to actuate the control element 4 starting from the position s₃, the counter pressure on the control element 4 initially rises sharply. This increase in counterpressure is by design. In the embodiments, the control element 4 must overcome a detent cam, which represents a resistance for the control element 4. Due to the greater force to be applied by the operator, the control element 4 travels the remaining distance to the position s₄ very quickly and suddenly after overcoming the greatest counterpressure. Therefore, the volume flow in this travel path section of the control element 4 increases very quickly over time. This is perceived by the operator as a jump in the volume flow. Suddenly, a larger volume flow and thus also a higher pressure are available. The boost function is activated. After overcoming the greatest counterpressure between the positions s₃ and s₄, the counterpressure between the positions s₄ and s₅ increases only moderately.

If the operator stops actuating the control element 4 in the position s₅, the control element 4 is pressed back into the position s₀ due to the spring. On the path of the control element 4 from the position s₅ to the position s₀, the main line valve 62 is closed in the position s₁.

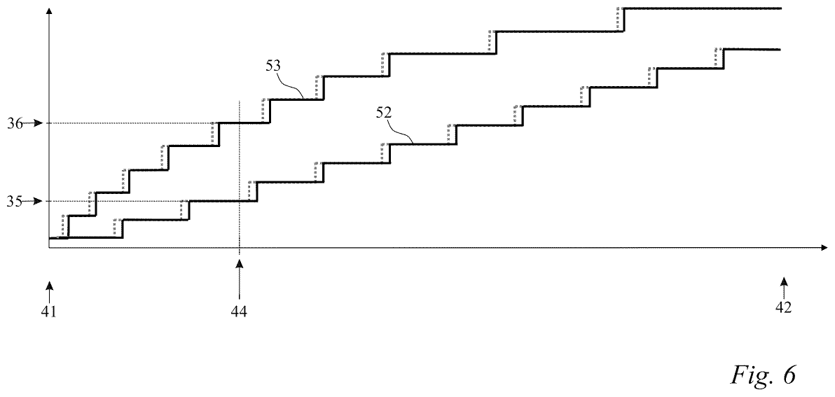

As shown in FIGS. 1 and 2, the pressure washer 1 comprises a selector element 11. The selector element 11 is used to select at least two different characteristic curves 51, 52, 53, in particular at least three different characteristic curves (FIGS. 5b and 6), each with a different relationship between the position of the control element 4 and the pressure value 34, 35, 36. By selecting a characteristic curve 51, 52, 53 using the selector element 11, the assignment of the position 24, 25, 26 of the control element 4 to the pressure value 34, 35, 36 can be set. By selecting a characteristic curve 51, 52, 53 using the selector element 11, the assignment of the position 24, 25, 26 of the control element 4 to the pressure value 34, 35, 36 can be changed. This is shown, for example, in FIG. 5b. In the position of the control element 4, denoted by the reference numeral 44, between the start position 41 and the end position 42, a different pressure value 34, 35, 36 is present, depending on which characteristic curve 51, 52, 53 is selected. The smallest pressure value 34 is assigned to the first characteristic curve 51. The middle pressure value 35 is assigned to the second characteristic curve 52. The largest pressure value 36 is assigned to the third characteristic curve 53. All pressure values 34, 35 and 36 are present at the same position 44 of the control element 4. If the first characteristic curve 51 is selected using the selector element 11, the lowest pressure value 34 is present at the position 44 of the control element 4. If the second characteristic curve 52 is selected using the selector element 11, the second pressure value 35 is present at the position 44 of the control element 4. If the third characteristic curve 53 is selected using the selector element 11, the greatest pressure value 36 is present at the position 44 of the control element 4.

The pressure washer 1 is designed such that the selection of a specific characteristic curve 51, 52, 53 is communicated to the control unit 66 by means of the selector element 11. The control unit 66 then links the position of the control element 4, which is also communicated to it, to a set pressure value in accordance with the set characteristic curve 51, 52, 53. However, it can also be provided that the linking of positions of the control element along the travel path 8 and the pressure value 34, 35, 36 set by the respective characteristic curve 51, 52, 53 takes place at a different point, for example directly by the control element 4. In the exemplary embodiment, the characteristic curve 51, 52, 53 selected by the selector element 11 is transmitted to the control unit 66 by means of the transmitter unit 63. In the exemplary embodiment, this is done wirelessly by an electromagnetic signal 65. In accordance with the position of the control element 4 and in accordance with the selected characteristic curve 51, 52, 53, the pressure regulator 7 adjusts the pressure in the main line 5, in particular in the pressure chamber 10, as described above. In the exemplary embodiment, this is done by correspondingly adjusting the open flow cross-section of the bypass line 12 by means of the bypass valve 13 and the servomotor 16. It can also be provided that the characteristic curves do not link the positions of the control element 4 to different pressure values, but directly to a specific position of the bypass valve 13.

In the exemplary embodiment, the selector element 11 is arranged on the hand-held spray unit 14. In particular, the selector element 11 is non-detachably arranged on the hand-held spray unit 14. In particular, the selector element 11 is arranged on the hand-held spray unit 14 in such a way that the selector element 11 can be operated by a user with the thumb of one hand while, at the same time, a three-jointed finger of the same hand rests against the control element 4. Three-jointed fingers are the index finger, the middle finger, the ring finger, and the little finger. The thumb is not a three-jointed finger, but a two-jointed finger.

The selector element 11 can be a digital component. The selector element 11 can have an interface to the operator for selecting the various characteristic curves 51, 52, 53. The interface can be designed in the form of a touch screen. However, other configurations of the interface, for example in the form of a mechanical rotary switch, are also conceivable.

Various nozzles can be arranged at the spray opening 6 of the pressure washer 1. By selecting different characteristic curves 51, 52, 53 using the selector element 11, the assignment of positions 24, 25, 26 of the control element 4 to the pressure value 31, 32, 33, 34, 35, 36 can be changed, with the same nozzle being arranged at the spray opening 6 unchanged.

As shown in FIG. 5, the second characteristic curve 52 lies completely above the first characteristic curve 51. In the second characteristic curve 52, a higher pressure value 32 is always set for the same position of the control element 4 than in the first characteristic curve 51. In an analogous manner, the third characteristic curve 53 lies completely above the second characteristic curve 52.

The pressure washer 1 is configured to allow a change between the first characteristic curve 51 and the second characteristic curve 52, or between the second characteristic curve 52 and the third characteristic curve 53, by actuating the selector element 11 during operation of the pressure washer 1, in particular during operation of the motor 61 of the high-pressure pump 3. In particular, a change between the first characteristic curve 51 and the second characteristic curve 52, in particular between the second characteristic curve 52 and the third characteristic curve 53, is possible by actuating the selector element 11 while the control element 4 is actuated.

As shown in FIGS. 5 and 6, all characteristic curves 51, 52, 53 are free of intersection points with other characteristic curves 51, 52, 53. As shown in FIG. 5b, the at least two, in particular the at least three characteristic curves 51, 52, 53 have different slopes at least in sections. In the exemplary embodiment, the characteristic curves 51, 52, 53 all have different slopes in the same position of the control element 4. With the same distance traveled by the control element 4 along the travel path 8 of the control element 4, a different change in the set pressure value 31, 32, 33 is brought about due to the different slopes of the characteristic curves 51, 52, 53.

The characteristic curves 52 and 53 shown in FIG. 6 also have different slopes. The term “slopes” is not to be understood in a strictly mathematical sense. The increase in the pressure values as a function of a specific, equal distance traveled along the travel path 8 of the control element 4 is different due to the different slopes.

As shown in FIG. 5b, the pressure value 37, 38, 39 set in the non-actuated position, in particular in the start position 41 of the control element 4, is different depending on the characteristic curve 51, 52, 53 selected by means of the selector element 11. The first pressure value 37 assigned to the first characteristic curve 51 is smaller than the second pressure value 38 assigned to the second characteristic curve 52. The second pressure value 38 is smaller than the third pressure value 39 assigned to the third characteristic curve 53.

As shown in FIG. 5b, the control element 4 has a boost position 43. The control element 4 passes the end position 42 before reaching the boost position 43 along the travel path 8 starting from the start position 41. During the transition from the end position 42 to the boost position 43, the pressure value set by the control element 4 increases abruptly, as shown in FIG. 5b. In FIG. 5b, the boost position 43 extends between the positions s₄ and s₅ of FIG. 5a. In the boost position, the bypass valve 13 is completely closed in the exemplary embodiment. In FIG. 5b, a pressure value of 110% is shown with a dashed line. This is symbolic and is intended to indicate that the pressure washer can be briefly overloaded in the boost position 43 of the control element 4.

What is claimed is:

1. A pressure washer, comprising:
a port (2) for a liquid source (17);
a high-pressure pump (3);
a main line (5), through which liquid can be conveyed from the port (2) to a spray opening (6) of the main line (5) by the high-pressure pump (3);
a control element (4) for setting a pressure value (31, 32, 33) for a pressure in the main line (5); and
a pressure regulator (7) that adjusts the pressure in the main line (5) in accordance with the pressure value (31, 32, 33) set by the control element (4),
wherein the main line (5) has a suction chamber (9) between the port (2) and the high-pressure pump (3),
wherein the main line (5) has a pressure chamber (10) between the high-pressure pump (3) and the spray opening (6),
wherein the pressure regulator (7) has a bypass line (12) with a bypass valve (13),
wherein the bypass line (13) fluidically connects the pressure chamber (10) to the suction chamber (9),
wherein an open cross-sectional area of the bypass line (12) can be adjusted by the bypass valve (13) to regulate the pressure in the pressure chamber (10),
wherein the pressure regulator (7) adjusts the open cross-sectional area of the bypass valve (13) depending on the pressure value (31, 32, 33) set by the control element (4),
wherein the control element (4) is continuously adjustable along a travel path (8),
wherein a specific pressure value (31, 32, 33) is set based on a position of the control element (4),
wherein the travel path (8) of the control element (4) has a plurality of travel path sections (21, 22, 23, 21′, 22′, 23′) directly adjacent to one another,
wherein each travel path section (21, 22, 23, 21′, 22′, 23′) comprises a plurality of different positions (24, 25, 26) of the control element (4),
wherein a single pressure value (31, 32, 33) is set by the control element (4) in each travel path section (21, 22, 23, 21′, 22′, 23′), and
wherein at least two of the pressure values (31, 32, 33) are different.

2. The pressure washer according to claim 1,
wherein the pressure values (31, 32, 33) in the travel path sections (21, 22, 23, 21′, 22′, 23′) increase at least within a subsection (27) along the travel path (8) from a start position (41) of the subsection (27) with a low pressure value (31) to an end position (42) of the subsection (27) with a high pressure value (40).

3. The pressure washer according to claim 2,
wherein the subsection (27) extends over an entirety of the travel path (8) of the control element (4).

4. The pressure washer according to claim 2,
wherein a relationship between the pressure values (31, 32, 33) and the travel path sections (21, 22, 23, 21′, 22′, 23′) has a hysteresis, so that a division of the travel path (8) into the travel path sections (21, 22, 23, 21′, 22′, 23′) depends on which of the pressure values (31, 32, 33) the control element (4) has set before entering an adjacent one of the travel path sections (21, 22, 23, 21′, 22′, 23′).

5. The pressure washer according to claim 2,
wherein a relationship between the pressure values (31, 32, 33) and the travel path sections (21, 22, 23, 21′, 22′, 23′) has a hysteresis, so that a division of the travel path (8) into the travel path sections (21, 22, 23, 21′, 22′, 23′) depends on whether the control element (4) moves toward the start position (41) or toward the end position (42).

6. The pressure washer according to claim 4,
wherein the travel path sections (21, 22, 23, 21′, 22′, 23′) each have an edge region (28, 29) in which the control element (4) sets a larger pressure value (32, 33) or a smaller pressure value (31, 32) depending on which pressure value (31, 32, 33) the control element (4) has set immediately before entering the edge region (28, 29).

7. The pressure washer according to claim 4,
wherein the travel path sections (21, 22, 23, 21′, 22′, 23′) each have an edge region (28, 29) in which the control element (4) sets a larger pressure value (32, 33) or a smaller pressure value (31, 32) depending on which pressure value (31, 32, 33) the control element (4) has set immediately before entering the edge region (28, 29) and depending on whether the control element (4) moves toward the start position (41) or toward the end position (42).

8. The pressure washer according to claim 1,
wherein the pressure washer (1) is designed such that the high-pressure pump (3) is operated at a constant output regardless of the position of the control element (4) during operation of the pressure washer (1).

9. A pressure washer, comprising:
a port (2) for a liquid source (17);
a high-pressure pump (3);
a main line (5), through which liquid can be conveyed from the port (2) to a spray opening (6) of the main line (5) by the high-pressure pump (3);
a control element (4) for setting a pressure value (31, 32, 33) for a pressure in the main line (5); and
a pressure regulator (7) that adjusts the pressure in the main line (5) in accordance with the pressure value (31, 32, 33) set by the control element (4),
wherein the control element (4) is continuously adjustable along a travel path (8),
wherein a specific pressure value (31, 32, 33) is set based on a position of the control element (4),
wherein the pressure washer (1) has a selector element (11) for selecting one of at least two characteristic curves (51, 52, 53), each with a different relationship between the position of the control element (4) and the pressure value (34, 35, 36), and
wherein an assignment of the position (24, 25, 26) of the control element (4) to the pressure value (34, 35, 36) can be changed by selecting another of the at least two characteristic curves (51, 52, 53) using the selector element (11).

10. The pressure washer according to claim 9,
wherein the pressure washer (1) has a hand-held spray unit (14),
wherein the spray opening (6) is arranged on the hand-held spray unit (14), and
wherein the selector element (11) is arranged on the hand-held spray unit (14).

11. The pressure washer according to claim 10,
wherein the control element (4) is arranged on the hand-held spray unit (14).

12. The pressure washer according to claim 11,
wherein the selector element (11) is arranged on the hand-held spray unit (14) such that it can be operated by a user with the thumb of one hand while, at the same time, a three-jointed finger of the same hand rests against the control element (4).

13. The pressure washer according to claim 10,
wherein different nozzles can be arranged at the spray opening (6), and
wherein the assignment of the position (24, 25, 26) of the control element (4) and the pressure value (31, 32, 33) can be changed by selecting different ones of the at least two characteristic curves (51, 52, 53) using the selector element (11) while a same one of the different nozzles remains arranged at the spray opening (6) unchanged.

14. The pressure washer according to claim 9,
wherein a second characteristic curve (52) of the at least two characteristic curves (51, 52, 53) lies completely above a first characteristic curve (51) of the at least two characteristic curves (51, 52, 53), so that a greater pressure value (32) is set for the second characteristic curve (52) than for the first characteristic curve (51) at all positions of the control element (4).

15. The pressure washer according to claim 14,
wherein during operation of the pressure washer (1), a change between the first characteristic curve (51) and the second characteristic curve (52) is possible by actuating the selector element (11).

16. The pressure washer according to claim 14,
wherein any one of the at least two characteristic curves (51, 52, 53) is free of intersection points with any other of the at least two characteristic curves (51, 52, 53).

17. The pressure washer according to claim 9,
wherein the at least two characteristic curves (51, 52, 53) have different slopes at least in sections, so that a different change in the set pressure value (31, 32, 33) is brought about with a same distance traveled along the travel path (8) of the control element (4).

18. The pressure washer according to claim 9,
wherein the control element (4) has a start position (41), and
wherein the pressure value (37, 38, 39) set in the start position (41) is different depending on which one of the at least two characteristic curves (51, 52, 53) is selected by the selector element (11).

19. The pressure washer according to claim 9,
wherein the control element (4) has an end position (42),
wherein the control element (4) has a boost position (43),
wherein the control element (4) passes the end position (42) before reaching the boost position (43) along the travel path (8) starting from the start position (41), and
wherein the pressure value (32, 33) set by the control element (4) rises abruptly during a transition from the end position (42) to the boost position (43).
